(19) United States
(12) Patent Application Publication
(10) Pub. No.: US 2017/0344430 A1
(43) Pub. Date: Nov. 30, 2017

(54) METHOD AND APPARATUS FOR DATA CHECKPOINTING AND RESTORATION IN A STORAGE DEVICE

(71) Applicant: Intel Corporation, Santa Clara, CA (US)

(72) Inventors: Teddy Gordon Greer, Freemont, CA (US); Gamil A. Cain, El Dorado Hills, CA (US)

(73) Assignee: Intel Corporation, Santa Clara, CA (US)

(21) Appl. No.: 15/162,718

(22) Filed: May 24, 2016

(51) Int. Cl. G06F 11/14

(52) U.S. Cl. CPC G06F 11/1451; G06F 11/1469; G06F 2201/84

(57) ABSTRACT

In one embodiment, an apparatus comprises a storage device to store a reference namespace comprising a plurality of logical blocks that correspond to physical blocks of a memory, to receive a request to create a first snapshot namespace based on the reference namespace, and to initialize a plurality of logical blocks of the first snapshot namespace to map to corresponding logical blocks of the reference namespace.

### FIELD

The present disclosure relates in general to the field of computer development, and more specifically, to data checkpointing and restoration in a storage device.

### BACKGROUND

A computer system may include one or more central processing units (CPUs) coupled to one or more storage devices. A CPU may include a processor to execute an operating system and other software applications that utilize the storage devices coupled to the CPU. The software applications may request various operations relating to the storage devices, such as the creation of a namespace, a write to a logical block of a namespace, and a read from a logical block of a namespace.

### BRIEF DESCRIPTION OF THE DRAWINGS

FIG. 1 illustrates a block diagram of components of a computer system in accordance with certain embodiments.

FIG. 2 illustrates an example reference namespace and two temporal instances of a snapshot namespace based on the reference namespace that may be stored by a storage device of a computer system in accordance with certain embodiments.

FIG. 3 illustrates an example reference namespace and a snapshot namespace after a merge operation has occurred in accordance with certain embodiments.

FIG. 4 illustrates an example snapshot namespace that is based off of another snapshot namespace in accordance with certain embodiments.

FIG. 5 illustrates an example flow for creating, writing to, and reading from a snapshot namespace in accordance with certain embodiments.

Like reference numbers and designations in the various drawings indicate like elements.

### DETAILED DESCRIPTION

Although the drawings depict particular computer systems, the concepts of various embodiments are applicable to any suitable integrated circuits and other logic devices. Examples of devices in which teachings of the present disclosure may be used include desktop computer systems, server computer systems, storage systems, handheld devices, tablets, other thin notebooks, systems on a chip (SOC) devices, and embedded applications. Some examples of handheld devices include cellular phones, digital cameras, personal digital assistants (PDAs), and handheld PCs. Embedded applications may include a microcontroller, a digital signal processor (DSP), a system on a chip, network computers (NetPC), set-top boxes, network hubs, wide area network (WAN) switches, or any other system that can perform the functions and operations taught below. Various embodiments of the present disclosure may be used in any suitable computing environment, such as a personal computer, a server, a mainframe, a cloud computing service provider infrastructure, a datacenter, a communications service provider infrastructure (e.g., one or more portions of an Evolved Packet Core), or other environment comprising a group of computing devices.

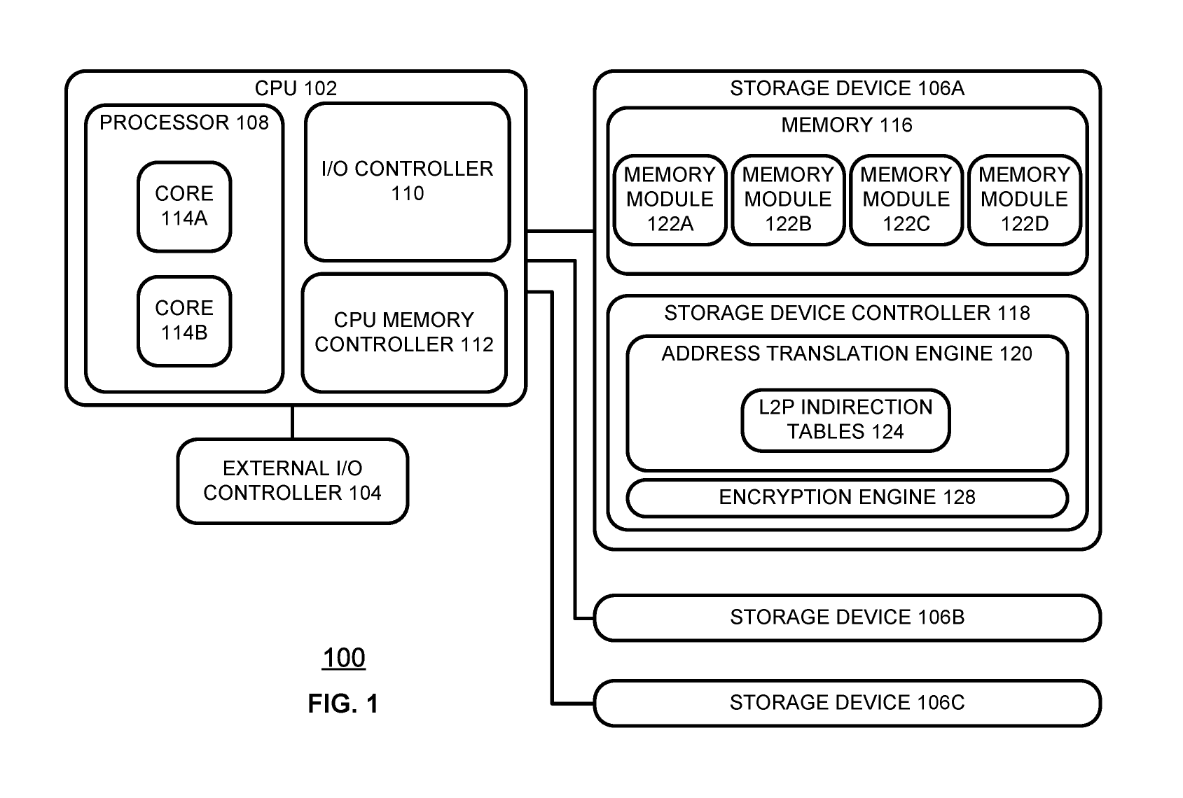

FIG. 1 illustrates a block diagram of components of a computer system 100 in accordance with certain embodiments. System 100 includes a central processing unit (CPU) 102 coupled to an external input/output (I/O) controller 104 and a plurality of storage devices 106. During operation, data may be transferred between storage devices 106 and the CPU 102. In various embodiments, particular data operations involving a storage device 106 may be managed by an operating system or other software application executed by processor 108.

Backing up data during a checkpoint or other backup operation usually involves a computing host (e.g., any suitable entity, such as a CPU or other logic device, operable to communicate with a storage device) instructing a storage device to physically copy data from one media to another media or another physical location on the same media. However, physically moving the data may be time consuming and may involve complex algorithms in order to be fault tolerant.

Various embodiments of the present disclosure leverage internal mechanisms of a storage device 106 to reduce the physical movement of data involved in backing up and restoring data, resulting in nearly instantaneous restoration of data that is backed up. In various embodiments, the burden on the computing host is drastically reduced as the computing host does not manage the operations of the backup and restoration functions, but merely initiates a backup or restoration function and the underlying operations are then performed by the storage device.

A storage device 106 may store a namespace. A namespace may be a logical partition of a memory. For example, a namespace may be a directory (e.g., a storage partition assigned to a drive letter) that may comprise a plurality of logical blocks which may be used to store data. The logical blocks may be any suitable size, such as 512 Bytes, 4 Kilo Bytes (KB), or other suitable sizes. The logical blocks expose memory regions of the storage device 106 in logical groupings to a computing host (and software running on the computing host) coupled to the storage device. The computing host may reference these logical blocks when performing operations involving the storage device. For example, the computing host may include one or more logical addresses or other identifiers of one or more logical blocks in commands for the storage device. Thus, a logical address space that references the logical blocks is provided to a computing host. The storage device may also include a physical address space that identifies the actual physical locations of the memory regions that store data written to the storage device 106 by the computing host. In various embodiments, the physical address space is not exposed to the computing host. The logical blocks of a namespace may correspond to physical blocks on the storage device 106 that store data written to the storage device 106 using that namespace. A logical block of a namespace may map to the corresponding physical block on the storage device. That is, the logical block may be associated with data that includes a reference (e.g., a physical address) to the corresponding physical block. When a logical block is written to by a computing host, the storage device may reference such data to determine which physical block the data should be written to.

In an embodiment, a namespace stored by storage device 106 is designated as a reference namespace. Data of a reference namespace may provide a basis for an additional namespace. For example, the computing host may issue a command to the storage device 106 to create a snapshot namespace based on a reference namespace. The snapshot namespace is to include a plurality of logical blocks that map to the logical blocks of the reference namespace. That is, the logical block of the snapshot namespace is associated with data that includes a reference to a corresponding logical block of the reference namespace (which itself may include a reference to a physical block storing data for the logical block of the reference namespace). Thus, a logical block of a snapshot namespace may indirectly (through the corresponding logical block of the reference namespace) map to the physical block storing the data. Thus, when a series of such logical blocks are created in a snapshot namespace, it may appear to a computing host accessing the snapshot namespace as if all of the data from the reference namespace has been copied to the snapshot namespace. However, none of the data residing on the physical media of the storage device 106 has been copied.

As will be described herein, the snapshot namespace may be modified, merged with a reference namespace, rolled back to an earlier state, or may be used as a basis for an additional snapshot namespace. In various embodiments, at least some of these operations may involve updating mappings associated with logical blocks of a namespace instead of physically moving data and thus may occur much more quickly than the performance of such operations by physically moving the underlying data of the namespaces.

Embodiments of the present disclosure may offer various technical advantages, such as speeding up the creation of namespaces, reducing the time to roll back a namespace to a previous state, reducing the amount of physical memory used to implement multiple namespaces (since multiple namespaces may refer to one instance of physical data), and increasing the lifespan of the storage device (since the amount of physical copying of data is reduced), among other advantages.

CPU 102 comprises a processor 108, such as a microprocessor, an embedded processor, a digital signal processor (DSP), a network processor, a handheld processor, an application processor, a co-processor, a system on a chip (SOC), or other device to execute code (i.e., software instructions). Processor 108, in the depicted embodiment, includes two processing elements (cores 114A and 114B in the depicted embodiment), which may include asymmetric processing elements or symmetric processing elements. However, a processor may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core 114 may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

In various embodiments, the processing elements may also include one or more arithmetic logic units (ALUs), floating point units (FPUs), caches, instruction pipelines, interrupt handling hardware, registers, or other hardware to facilitate the operations of the processing elements.

I/O controller 110 is an integrated I/O controller that includes logic for communicating data between CPU 102 and I/O devices, which may refer to any suitable devices capable of transferring data to and/or receiving data from an electronic system, such as CPU 102. For example, an I/O device may comprise an audio/video (A/V) device controller such as a graphics accelerator or audio controller; a data storage device controller, such as a flash memory device, magnetic storage disk, or optical storage disk controller; a wireless transceiver; a network processor; a network interface controller; or a controller for another input devices such as a monitor, printer, mouse, keyboard, or scanner; or other suitable device. In a particular embodiment, an I/O device may comprise a storage device 106 coupled to the CPU 102 through I/O controller 110.

An I/O device may communicate with the I/O controller 110 of the CPU 102 using any suitable signaling protocol, such as peripheral component interconnect (PCI), PCI Express (PCIe), Universal Serial Bus (USB), Serial Attached SCSI (SAS), Serial ATA (SATA), Fibre Channel (FC), IEEE 802.3, IEEE 802.11, or other current or future signaling protocol. In particular embodiments, I/O controller 110 and the underlying I/O device may communicate data and commands in accordance with a logical device interface specification such as Non-Volatile Memory Express (NVMe) (e.g., as described by one or more of the specifications available at www.nvmexpress.org/specifications/) or Advanced Host Controller Interface (AHCI) (e.g., as described by one or more AHCI specifications such as Serial ATA AHCI: Specification, Rev. 1.3.1 available at http://www.intel.com/content/www/us/en/io/serial-ata/serial-ata-ahci-spec-rev1-3-1.html). In various embodiments, I/O devices coupled to the I/O controller may be located off-chip (i.e., not on the same chip as CPU 102) or may be integrated on the same chip as the CPU 102.

CPU memory controller 112 is an integrated memory controller that includes logic to control the flow of data going to and from the storage devices 106. CPU memory controller 112 may include logic operable to read from a storage device 106, write to a storage device 106, or to request other operations from a storage device 106. In various embodiments, CPU memory controller 112 may receive write requests from cores 114 and/or I/O controller 110 and may provide data specified in these requests to a storage device 106 for storage therein. CPU memory controller 112 may also read data from a storage device 106 and provide the read data to I/O controller 110 or a core 114. During operation, CPU memory controller 112 may issue commands including one or more addresses (e.g., row and/or column addresses) of the storage device 106 in order to read data from or write data to memory (or to perform other operations). CPU memory controller 112 may also issue commands to create a namespace, create a snapshot namespace, merge a reference namespace with a snapshot namespace, roll back a snapshot namespace to an earlier state, delete a namespace, or other suitable commands (including any of the commands described herein). In some embodiments, CPU memory controller 112 may be implemented on the same chip as CPU 102, whereas in other embodiments, CPU memory controller 112 may be implemented on a different chip than that of CPU 102.

The CPU 102 may also be coupled to one or more other I/O devices through external I/O controller 104. In a particular embodiment, external I/O controller 104 may couple a storage device 106 to the CPU 102. External I/O controller 104 may include logic to manage the flow of data between one or more CPUs 102 and I/O devices. In particular embodiments, external I/O controller 104 is located on a motherboard along with the CPU 102. The external I/O controller 104 may exchange information with components of CPU 102 using point-to-point or other interfaces.

A storage device 106 may store any suitable data, such as data used by processor 108 to provide functionality of computer system 100. For example, data associated with programs that are executed or files accessed by cores 114 may be stored in storage device 106. Thus, a storage device 106 may include a system memory that stores data and/or sequences of instructions that are used or executed by the cores 114. In various embodiments, a storage device 106 may store persistent data (e.g., a user's files or software application code) that remains stored even after power to the storage device 106 is removed. A storage device 106 may be dedicated to CPU 102 or shared with other devices (e.g., another CPU or other device) of computer system 100.

In the embodiment depicted, storage device 106A includes a memory 116 comprising a plurality of memory modules 122A-D (a storage device may include any suitable number of memory modules 122) and storage device controller 118. A memory module 122 includes a plurality of memory cells that are each operable to store one or more bits. The cells of a memory module 122 may be arranged in any suitable fashion, such as in columns and rows, tracks and sectors, three dimensional structures, or other manner. In various embodiments, the cells may be logically grouped into banks, blocks, pages (wherein a page is a subset of a block), frames, bytes, sectors, file segments, or other suitable groups.

A memory module 122 may include non-volatile memory and/or volatile memory. Non-volatile memory is a storage medium that does not require power to maintain the state of data stored by the medium. Nonlimiting examples of nonvolatile memory may include any or a combination of: solid state memory (such as planar or 3D NAND flash memory or NOR flash memory), 3D crosspoint memory, storage devices that use chalcogenide phase change material (e.g., chalcogenide glass), byte addressable nonvolatile memory devices, ferroelectric memory, silicon-oxide-nitride-oxide-silicon (SONOS) memory, polymer memory (e.g., ferroelectric polymer memory), ferroelectric transistor random access memory (Fe-TRAM) ovonic memory, nanowire memory, electrically erasable programmable read-only memory (EEPROM), other various types of non-volatile random access memories (RAMs), and magnetic storage memory. In some embodiments, 3D crosspoint memory may comprise a transistor-less stackable cross point architecture in which memory cells sit at the intersection of words lines and bit lines and are individually addressable and in which bit storage is based on a change in bulk resistance. In particular embodiments, a memory module 122 with non-volatile memory may comply with one or more standards promulgated by the Joint Electron Device Engineering Council (JEDEC), such as JESD218, JESD219, JESD220-1, JESD223B, JESD223-1, or other suitable standard (the JEDEC standards cited herein are available at www.jedec.org).

Volatile memory is a storage medium that requires power to maintain the state of data stored by the medium. Examples of volatile memory may include various types of random access memory (RAM), such as dynamic random access memory (DRAM) or static random access memory (SRAM). One particular type of DRAM that may be used in a memory module 122 is synchronous dynamic random access memory (SDRAM). In particular embodiments, DRAM of the memory modules 122 complies with a standard promulgated by JEDEC, such as JESD79F for Double Data Rate (DDR) SDRAM, JESD79-2F for DDR2 SDRAM, JESD79-3F for DDR3 SDRAM, or JESD79-4A for DDR4 SDRAM (these standards are available at www.jedec.org). Such standards (and similar standards) may be referred to as DDR-based standards and communication interfaces of the storage devices 106 that implement such standards may be referred to as DDR-based interfaces.

Storage devices 106 may comprise any suitable type of memory and are not limited to a particular speed, technology, or form factor of memory in various embodiments. For example, a storage device 106 could be a disk drive (such as a solid state drive or a hard disk drive), a memory module (e.g., a dual in-line memory module), or other type of storage device. Moreover, computer system 100 could include multiple different types of storage devices 106. For example, computer system may include tiered storage, such as a first tier of flash hard drives and a second tier or magnetic hard drives. Storage devices 106 may include any suitable interface to communicate with CPU memory controller 112 or I/O controller 110 using any suitable communication protocol such as a DDR-based protocol, PCI, PCIe, USB, SAS, SATA, FC, System Management Bus (SMBus), or other suitable protocol. Storage devices 106 may also include a communication interface to communicate with CPU memory controller 112 or I/O controller 110 in accordance with any suitable logical device interface specification such as NVMe, AHCI, or other suitable specification. In particular embodiments, storage device 106 may comprise multiple communication interfaces that each communicate using a separate protocol with CPU memory controller 112 and/or I/O controller 110.

Storage device controller 118 may include logic to receive requests from CPU 102 (e.g., via CPU memory controller 112 or I/O controller 110), cause the requests to be carried out with respect to memory 116, and provide data associated with the requests to CPU 102 (e.g., via CPU memory controller 112 or I/O controller 110). Controller 118 may also be operable to detect and/or correct errors encountered during memory operation. In an embodiment, controller 118 also tracks the number of times particular cells (or logical groupings of cells) have been written to in order to perform wear leveling and/or to detect when cells are nearing an estimated number of times they may be reliably written to. In various embodiments, controller 118 may also monitor various characteristics of the storage device 106 such as the temperature or voltage and report associated statistics to the CPU 102. Storage device controller 118 can be implemented on the same chip, board, or device as memory 116 or on a different chip, board, or device. For example, in some environments, storage device controller 118 may be a centralized storage controller that manages memory operations for multiple different memories 116 (which could each be of the same type or could be of different types) of computer system 100 (and thus could provide storage device controller functionality described herein to any of the memories to which it is coupled).

In various embodiments, the storage device 106 also includes an address translation engine 120. In the depicted embodiment, the address translation engine 120 is shown as part of the storage device controller 118, although in various embodiments, the address translation engine 120 may be separate from the storage device controller 118 and communicably coupled to the storage device controller 118. In various embodiments, the address translation engine 120 may be integrated on the same chip as the storage device controller 118 or on a different chip.

In various embodiments, address translation engine 120 may include logic to store and update a mapping between a logical address space (e.g., an address space visible to a computing host coupled to the storage device 106) and the physical address space of the memory 116 (which may or may not be exposed to the computing host). The logical address space may expose a plurality of logical groups (i.e., logical blocks) of data which is physically stored on corresponding physical groups (i.e., physical blocks) of memory addressable through the physical address space of the storage device 106. A physical address of the physical address space may comprise any suitable information identifying a physical memory location (e.g., a location within memory 116) of the storage device 106, such as an identifier of the memory module 122 on which the physical memory location is located, one or more rows of the physical memory location, one or more columns of the physical memory location, or other suitable identifiers or encodings thereof.

The mapping between the logical address space and the physical address space may be performed in any suitable manner. In various embodiments, storage device 116 maintains one or more logical to physical indirection (L2P) tables 124. In particular embodiments, L2P tables 124 may comprise a plurality of mapping entries that map logical blocks to physical blocks. For example, an entry may map one or more addresses in the logical address space to one or more addresses in the physical address space. In one example, each L2P table entry may map a logical block of the logical address space to a physical block of memory 116. The blocks may be any suitable size, such as 1 KB, 4 KB, or other suitable size. Storage device 116 may maintain any suitable number of L2P tables 124 using any number of storage media. As used herein, a portion of a larger L2P table may itself be referred to as an L2P table. For example, storage device 116 may maintain a global L2P table in a storage medium (e.g., memory 116 or other dedicated storage), and the global L2P table may include portions that each are associated with distinct namespaces. Thus, as used herein, an L2P table 124 for a first namespace may refer to a portion of the global L2P table while another L2P table 124 for a second namespace may refer to another portion of the global L2P table.

The address translation engine 120 or other portion of storage device 106 may include any suitable memory type for storing the L2P tables 124 or other logical to physical mapping structures and any suitable logic for changing values stored in the L2P tables 124 or other mapping structures (e.g., in response to a request from the storage device controller 118) and reading values from the L2P tables 124 or other mapping structures (e.g., to provide the values to the storage device controller 118 for use in memory operations).

Storage media for L2P tables 124 may be included within the address translation engine 120 and/or storage device controller 118 or may be communicably coupled to the address translation engine and/or storage device controller. In various embodiments, storage media for L2P tables 124 may be integrated on the same chip as the storage device controller 118 and/or address translation engine 120 or may be implemented on a separate chip.

In various embodiments, the address translation engine 120 and/or storage device controller 118 may provide wear leveling through management of the address mappings of the L2P tables 124 or other mapping structures. In particular embodiments, the address translation engine 120 and/or storage device controller 118 may also prevent the use of bad memory cells (or logical grouping of cells) by not allowing physical addresses for the bad cells (or logical grouping of cells) to be mapped to the logical address space.

In various embodiments, prior to being written to memory, data may be encrypted by encryption engine 128 of the storage device 106. Encryption engine 128 is operable to receive data associated with a write command, encrypt the data, and provide the encrypted data to be written to memory 116. In some embodiments, the length of the encrypted data is the same as the length of the original data (thus simplifying the logical to physical mapping). Encryption engine 128 may also be operable to receive encrypted data retrieved from memory 116, decrypt the data into the form in which it was received (e.g., from a computing host), and provide the decrypted data to be sent to a computing host (e.g., in response to a command to read data). In various embodiments, the encryption engine 128 may be included within the storage device controller 118 or may be communicably coupled to the storage device controller. In some embodiments, the encryption engine 128 may be integrated on the same chip as the storage device controller 118 or may be implemented on a different chip. In various embodiments, because encryption is performed by storage device 116, the computing host does not need to manage encryption or decryption for backup and restoration operations.

In some embodiments, all or some of the elements of system 100 are resident on (or coupled to) the same circuit board (e.g., a motherboard). In various embodiments, any suitable partitioning between the elements may exist. For example, the elements depicted in CPU 102 may be located on a single die or package (i.e., on-chip) or any of the elements of CPU 102 may be located off-chip. Similarly, the elements depicted in storage device 106A may be located on a single chip or on multiple chips. In various embodiments a storage device 106 and a computing host (e.g., CPU 102) issuing commands associated with the namespace operations described herein to the storage device 106 may be located on the same circuit board or on the same device and in other embodiments the storage device 106 and the computing host may be located on different circuit boards or devices.

The components of system 100 may be coupled together in any suitable manner. For example, a bus may couple any of the components together. A bus may include any known interconnect, such as a multi-drop bus, a mesh interconnect, a ring interconnect, a point-to-point interconnect, a serial interconnect, a parallel bus, a coherent (e.g. cache coherent) bus, a layered protocol architecture, a differential bus, and a Gunning transceiver logic (GTL) bus. In various embodiments an integrated I/O subsystem includes point-to-point multiplexing logic between various components of system 100, such as cores 114, one or more CPU memory controllers 112, I/O controller 110, integrated I/O devices, direct memory access (DMA) logic (not shown), etc. In various embodiments, components of computer system 100 may be coupled together through one or more networks comprising any number of intervening network nodes, such as routers, switches, or other computing devices. For example, a computing host (e.g., CPU 102) and the storage device 106 may be communicably coupled through a network.

Although not depicted, system 100 may use a battery and/or power supply outlet connector and associated system to receive power, a display to output data provided by CPU 102, or a network interface allowing the CPU 102 to communicate over a network. In various embodiments, the battery, power supply outlet connector, display, and/or network interface may be communicatively coupled to CPU 102.

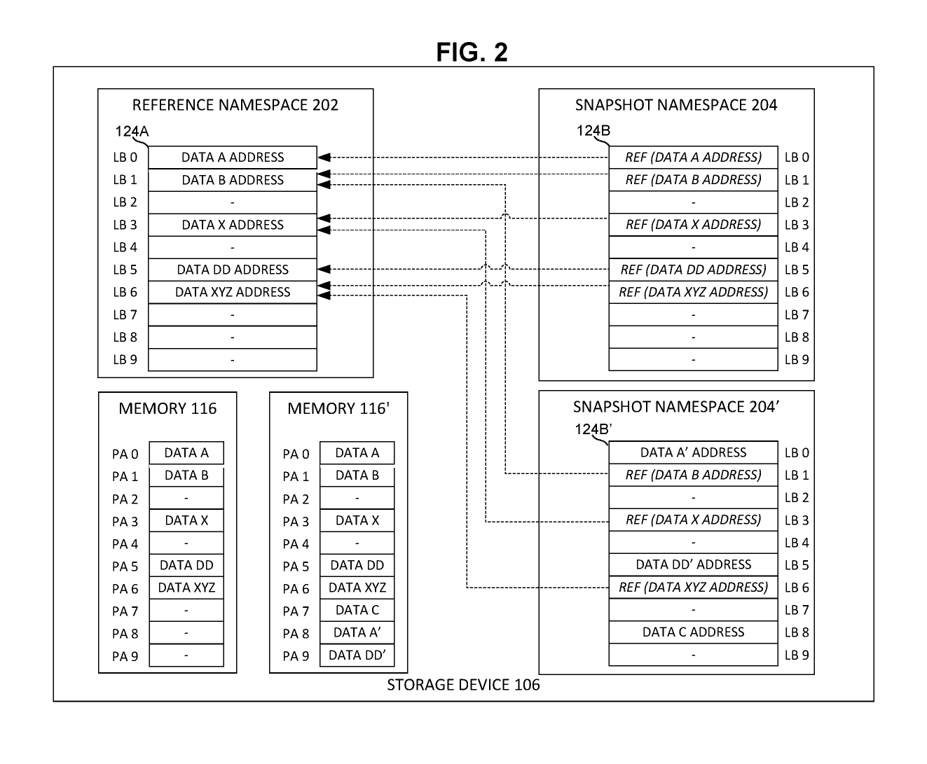

FIG. 2 illustrates an example reference namespace 202 and two temporal instances of a snapshot namespace 204 based on the reference namespace 202 that may be stored by a storage device 106 of a computer system in accordance with certain embodiments. FIG. 2 also illustrates an example state of memory 116 corresponding to example contents of memory when the snapshot namespace 204 is created and after the snapshot namespace has been modified.

In the embodiment depicted, the reference namespace 202 is associated with an L2P table 124A. L2P table 124A includes an entry for each logical block of the reference namespace 202. At least some of the entries may each include a mapping to (e.g., a physical address of) a physical block of memory 116 that stores data that has been written to the corresponding logical block (e.g., by a computing host). In various embodiments, if data has not been written to the logical block of the entry (or has been erased and/or unmapped), the entry may include a value indicating that the logical block is not currently written to rather than a mapping to a physical block (since in some instances the storage device 106 may wait until a logical block is written to before allocating a physical block for the logical block). A logical block that does not have a corresponding physical block (e.g., because the logical block has not yet been written to or has been erased and/or unmapped) may be referred to herein as an empty logical block. In various embodiments, a read performed on an empty logical block may return all zeros (or other predefined result).

In the embodiment depicted, the reference namespace 202 comprises a plurality of logical blocks LB 0 through LB 9 (of course a namespace may have any suitable number of logical blocks). Some of these logical blocks have data written to them. For example, data A has been written to LB 0, data B has been written to LB 1, data X has been written to LB 3, data DD has been written to LB 5, and data XYZ has been written to LB 6. The entries of L2P table 124A for logical blocks that have data written to them include mappings to physical addresses where the data is stored in memory 116. Thus, each of these logical blocks maps to the physical location of the data that has been written to the respective logical block. For example, the entry for LB 0 includes the physical address (PA) where data A is stored (PA 0 of memory 116), the entry for LB 1 includes the physical address where data B is stored (PA 1 of memory 116), and so on. In the embodiment depicted, LBs 2, 4, 7, 8, and 9 of the reference namespace 202 are empty logical blocks.

Snapshot namespace 204 represents the state of a snapshot namespace 204 based on the reference namespace 202 immediately after the creation of the snapshot namespace. In the embodiment depicted, snapshot namespace 204 is associated with an L2P table 124B. L2P table 124B includes an entry for each logical block of the snapshot namespace 204. Because snapshot namespace 204 is based on the reference namespace 202, the snapshot namespace includes (at least initially) the same number of logical blocks as reference namespace 202.

In the embodiment depicted, the snapshot namespace 204 comprises a plurality of logical blocks LB 0 through LB 9 that are initialized based on the reference namespace 202. For each logical block of the snapshot namespace, if the corresponding logical block of the reference namespace maps to a physical location of written data, the logical block of the snapshot namespace will be initialized to map to the logical block of the reference namespace. Accordingly, at least some of the logical blocks of the snapshot namespace 204 will reference the physical address of the data through the corresponding logical block of the reference namespace 202. As an example, because LB 0 of reference namespace 202 maps to the location of data A,

LB 0 of snapshot namespace is initialized to map to LB 0 of the reference namespace 202. Thus, in the embodiment depicted, the L2P table entry for LB 0 of the snapshot namespace 204 includes a pointer to the L2P table entry for LB 0 of the reference namespace (as indicated by the dotted arrow). Accordingly, the L2P table entries of snapshot namespace 204 that point back to corresponding L2P table entries of reference namespace 202 that include the addresses of various data are depicted as including a reference (REF) to an addresses of the data.

A mapping to another logical block may take any suitable form. As an example, the mapping may include an address associated with the other logical block (such as the address of the logical block in the logical address space or an address of the L2P table entry for the logical block). As another example, the mapping may include an indication of the reference namespace (and logic may be configured to reference the same relative logic block of the identified namespace). For example, the table entry for LBO of snapshot namespace 204 may include an identifier of the reference namespace 202. When a read is performed on LB 0 of the snapshot namespace, logic may see this identifier in the table entry of L2P table 124B and then access the contents of the table entry for the same relative block (i.e., LB 0) of the reference namespace 202.

When the snapshot namespace is initialized, if a logical block of the reference namespace 202 is empty, the corresponding logical block of the snapshot namespace 204 will be empty as well. For example, the logical block of the snapshot namespace 204 may be initialized with a value indicating that no corresponding physical block exists.

In the embodiment depicted, after the initialization of the snapshot namespace 204, the L2P table entries for LB 0, LB 1, LB 3, LB 5, and LB 6 of the snapshot namespace 204 each map to corresponding L2P table entries of the reference namespace 202, while the L2P table entries for LB 2, LB 4, LB 7, LB 8, and LB 9 of the snapshot namespace 204 do not map to corresponding L2P table entries of reference namespace 202, but rather may include an indication that physical blocks have not been allocated for these logical blocks.

After the snapshot namespace is initialized, any read of a logical block of the snapshot namespace 204 (that has not been modified since the snapshot namespace was initialized) will return the corresponding data from the same relative logic block of the reference namespace 202. In various embodiments, when snapshot namespace 204 is created and initialized, no physical blocks of memory 116 are allocated to store data of the snapshot namespace 204 (since the data of snapshot namespace 204 is already stored in the physical blocks previously allocated for writes made to the reference namespace 202). Thus, in various embodiments, a snapshot namespace 204 uses no additional physical storage until a user chooses to modify the initial data set, at which point physical storage is only used for the new data.

Memory 116 of FIG. 2 depicts an example state of memory immediately after the snapshot namespace 204 is initialized. Memory 116 includes physical blocks that store data A, B, X, DD and XYZ. The remaining blocks are available for additional data (i.e., they are not written to).

After the snapshot namespace 204 is initialized, the computing host may write to the logical blocks of the snapshot namespace 204, resulting in a modified snapshot namespace 204′. When an empty logical block of the snapshot namespace 204 (i.e., LB 2, 4, 7, 8, or 9) is written to, a physical block in memory 116 for the logical block may be allocated and then the data of the write command is written to the allocated physical block. The L2P table entry for the logical block is also updated to map to the physical block that was allocated (e.g., a physical address of the physical block may be written to the table entry). In the embodiment depicted, snapshot namespace 204′ represents snapshot namespace 204 after various logical blocks have been modified (e.g., written to). As depicted, LB 8 (which was previously empty) has been written with data C. This write has no effect on the reference namespace 202 (thus LB8 of the reference namespace is still empty). As depicted in memory 116′ (which represents the state of the memory with after the modifications depicted in snapshot namespace 204′ are made), data C is now stored in memory 116′ at PA 7. The L2P table entry for LB 8 of the snapshot namespace 204′ includes an address (e.g., PA 7) to the physical location storing data C.

When a logical block of the snapshot namespace 204 that already includes data (i.e., LB 0, 1, 3, 5, or 6) is written to (e.g., via a write command from a computing host), a physical block in memory 116 for the logical block being modified may be allocated and the underlying data (pointed to by the corresponding logical block of the reference namespace 202) is copied to the allocated physical block. The data of the write command is then written to the physical block (e.g., over all or a portion of the data that was just copied). The entry of the L2P table entry for the logical block of the snapshot namespace 204 is then updated (or it could be updated when the physical block is allocated) to map to the physical block that was allocated (e.g., a physical address of the physical block may be written to the table entry).

As an example, storage device 106 may receive a write command for logical block 0 of snapshot namespace 204. A determination is made that this is not an empty block (e.g., by determining that the L2P table entry does not have a value indicating the block is empty or by determining that the L2P table entry has a pointer to a logical block of another namespace). The L2P table entry of the logical block referenced by the table entry (i.e., LB 0 of reference namespace 202) is accessed and the physical address of data A is obtained. Data A is then copied from this location to a physical block that is allocated for LB 0 of the snapshot namespace 204′. The L2P table entry for LB 0 of snapshot namespace 204′ is updated to map to the physical block to which data A has been copied. Thus, LB 0 of the snapshot namespace 204′ no longer maps to LB 0 of the reference namespace 202. The write command is also performed on this physical block to modify data A to data A′. Accordingly, the L2P table entry for LB 0 is depicted as including an address (e.g., PA 8 as shown in memory 116′) for data A′. In the embodiment depicted, data DD is also modified and LB 5 of snapshot namespace 204′ is updated to include the address (e.g., PA 9 of memory 116′) of the modified data DD′.

After a snapshot namespace 204 has been modified (e.g., logical blocks of the snapshot namespace have been written to), a user may decide to roll back the changes made to the snapshot namespace. The computing host may send a roll back command for the snapshot namespace. The roll back command may specify any suitable information, such as the reference namespace that should serve as the basis for the rollback. The performance of the roll back command by storage device 106 results in the modified snapshot namespace 204′ being returned to the form the snapshot namespace was in immediately after initialization of the snapshot namespace. Physical data blocks (e.g., PA 7-9 of memory 116′) holding modified data for the modified snapshot namespace 204′ may be deallocated and/or erased. The L2P table 124B′ of the snapshot namespace 204′ is updated back to the initial state of the L2P table 124B. The roll back operation may be performed very quickly as none of the underlying data stored in memory 116 is moved, rather only the pointers stored in the L2P table of the snapshot namespace are modified.

In various embodiments, a reference namespace 202 may serve as the basis for multiple different snapshot namespaces 204. In such embodiments, each snapshot namespace may refer back to the data of the reference namespace (e.g., the logical blocks of each snapshot namespace may map to the same logical blocks of the reference namespace) and the snapshot namespaces may be modified independently (i.e., a change to one snapshot namespace does not affect the contents of the other snapshot namespace).

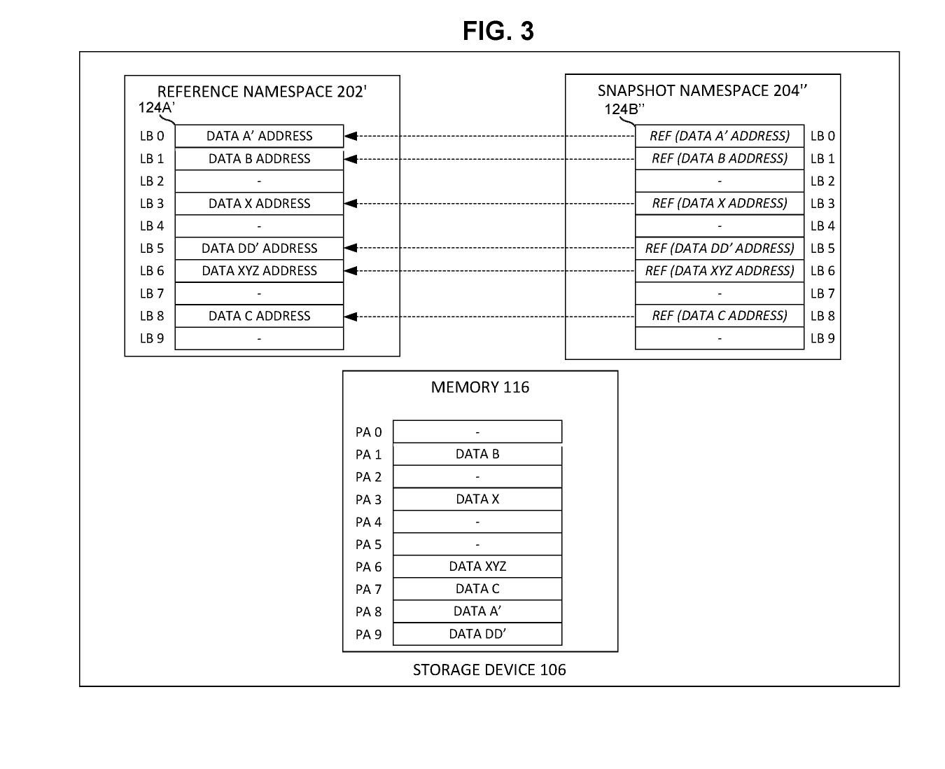

FIG. 3 illustrates a modified reference namespace 202′ and a modified snapshot namespace 204″ after a merge operation has occurred in accordance with certain embodiments. For purposes of illustration, it is assumed that the reference namespace 202 of FIG. 2 is merged with the modified snapshot namespace 204′. When a reference namespace is merged with a snapshot namespace, the logical blocks of the reference namespace are updated to map to the physical locations of the data of the snapshot namespace and the logical blocks of the snapshot namespace are updated to refer back to the logical blocks of the reference namespace (basically the snapshot namespace is re-initialized based on the updated reference namespace). From the computing host's perspective, the new reference namespace will appear to be identical to the snapshot namespace (i.e., from the host's perspective, the corresponding logical blocks of each namespace include the same data).

To accomplish the merge, the L2P table associated with the reference namespace is updated to include pointers to the physical location of any data that has been modified in the snapshot namespace. Thus, L2P table 124A′ includes the address of data A′ in the entry corresponding to LB 0, the address of data DD′ in the entry corresponding to LB 5, and the address of data C for the entry corresponding to LB 8. Physical blocks of data mapped to by the reference namespace that were modified in the snapshot namespace (e.g., the physical blocks storing data A and data DD) may be deallocated and/or deleted from memory 116. Similarly, any logical blocks of the reference namespace for which data was deleted in the corresponding snapshot namespace may result in the deletion of the logical blocks (e.g., by marking the logical blocks as empty) in the reference namespace (and may also result in the erasure of the data from memory 116). For example, if data B had been deleted from LB 1 of the snapshot namespace, data B may be deleted from PA 1 of memory 116 and the pointer to PA 1 in the L2P table 124A′ of the reference namespace 202′ may be removed.

After the reference namespace is updated, the snapshot namespace is reinitialized based on the reference namespace. Thus, the L2P table entries of the snapshot namespace 204″ now include mappings back to corresponding entries of the L2P table 124A′ of the reference namespace 202′. The snapshot namespace may then be further modified in a manner similar to that described above.

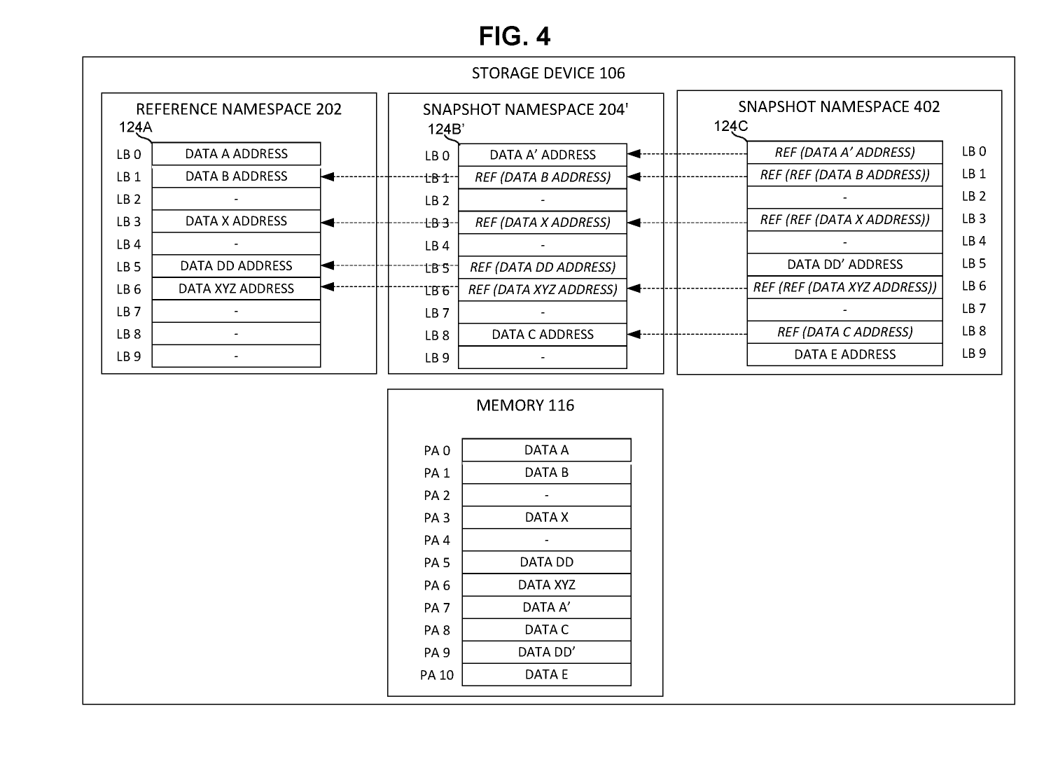

FIG. 4 illustrates an example snapshot namespace 402 that is based off of another snapshot namespace 204′ in accordance with certain embodiments. Snapshot namespace 402 may be created in response to a command to create a snapshot namespace using snapshot namespace 204′ as the reference namespace. Snapshot namespace 402 is initialized in a manner similar to that described above in connection with snapshot namespace 204. That is, empty logical blocks will be created in snapshot namespace 402 if the corresponding logical blocks of snapshot namespace 204′ are empty, and the other logical blocks of snapshot namespace 402 will map to corresponding logical blocks of snapshot namespace 202′.

Thus, when snapshot namespace 402 is created, LB 2, LB 4, LB 7, and LB 9 would each be initialized as empty blocks (LB 9 is later written to and thus is not depicted as an empty block) and LB 0, LB 1, LB 3, LB 5, LB 6, and LB 8 would each map to a corresponding logical block of snapshot namespace 204′ (and each of these blocks may include a physical address of data or another reference to a corresponding logical block of reference namespace 202). FIG. 4 assumes that data DD is later modified, thus the mapping from LB 5 of the snapshot namespace 402 to LB 5 of the snapshot namespace 204′ is not shown.

Thus, in the embodiment depicted, the L2P table entry for LB 0 of the snapshot namespace 402 includes a maping (e.g., pointer) to the corresponding L2P table entry of the snapshot namespace 204′, which includes the physical address (e.g., PA 7) of data A′. The L2P table entry for LB 1 of the snapshot namespace 402 includes a mapping to the corresponding L2P table entry of the snapshot namespace 204′, which includes a mapping to the corresponding L2P table entry of the reference namespace 202, which includes the physical address (e.g., PA 1) of data B. Thus, the L2P table entry for LB 1 of snapshot namespace 402 is depicted as including a reference to a reference to the address of data B. Logical blocks 3, 6 and 8 of snapshot namespace 402 similarly map to corresponding logical blocks of snapshot namespace 204′, which may include physical addresses or mappings to logical blocks of reference namespace 202. As indicated earlier, the figure assumes data DD has been modified by a write command to LB 5 of the snapshot namespace 402. A procedure similar to that described above may be performed, where the data DD is copied from the physical block pointed to by the snapshot namespace 204′ to a new physical block allocated for LB 5 of the snapshot namespace 402. Accordingly, LB 5 is shown as including a physical address to data DD′ rather than a mapping to a corresponding logical block of snapshot namespace 204′. Data writes to empty blocks of snapshot namespace 402 may also be performed in a manner similar to that described above with respect to snapshot namespace 204′. Similarly, a merge command may merge snapshot namespace 204′ and snapshot namespace 402 in a manner similar to that described above with respect to reference namespace 202′ and snapshot namespace 204″ or a roll back command may be performed to modify snapshot namespace 402 back into the form it had immediately after it was initialized.

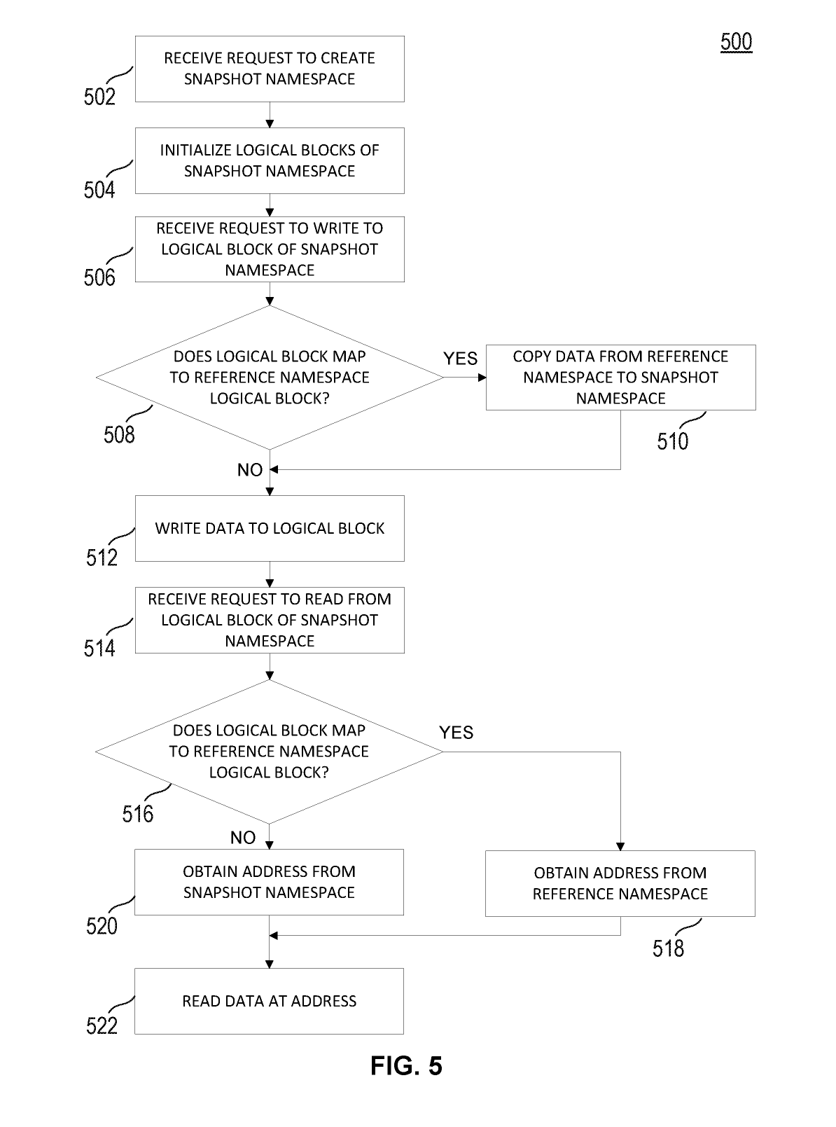

FIG. 5 illustrates an example flow 500 for creating, writing to, and reading from a snapshot namespace in accordance with certain embodiments. The flow 500 depicts example operations that may be performed by any suitable logic, such as one or more components of a storage device 106.

At 502, a request to create a snapshot namespace is received (e.g., from computing host). The request may specify a namespace that is to be used as a basis for the snapshot namespace (i.e., a reference namespace). At 504, logical blocks of the snapshot namespace are initialized. For logical blocks of the reference namespace that have been written to, corresponding logical blocks of the newly created snapshot namespace may refer back to these logical blocks. For empty logical blocks of the reference namespace, corresponding logical blocks of the snapshot namespace may also be empty.

At 506, a request to write to a logical block of the snapshot namespace is received (e.g., from a computing host). At 508, it is determined whether the logical block maps to a logical block of a reference namespace. If the logical block does map to a logical block of the reference namespace, then data is copied from the reference namespace to the snapshot namespace at 510. This may involve allocating a physical block in the memory 116 to store the data that is copied and mapping the physical block to the logical block of the snapshot namespace. At 512, the data is written to the physical block mapped to the logical block of the snapshot namespace.

At 514, a request to read from a logical block of the snapshot namespace is received. It is assumed that the request is to read from a logical block of the snapshot namespace that is not empty. At 516, it is determined whether the logical block identified in the read request maps to a logical block of the reference namespace. If the logical block of the snapshot namespace does map to a logical block in the reference namespace, the physical address of the data is obtained from the logical block in the reference namespace at 518. If the logical block of the snapshot namespace does not map to a logical block in the reference namespace (but instead itself includes the physical address of the data), physical address of the data is obtained from the snapshot namespace (e.g., by determining which physical block the logical block of the snapshot namespace is mapped to). At 522, the data is read from the physical address and returned to the requesting entity.

The flow described in FIG. 5 is merely representative of operations that may occur in particular embodiments. In other embodiments, additional operations may be performed by the components of system 100. Various embodiments of the present disclosure contemplate any suitable signaling mechanisms for accomplishing the functions described herein. Some of the operations illustrated in FIG. 5 may be repeated, combined, modified or deleted where appropriate. Additionally, operations may be performed in any suitable order without departing from the scope of particular embodiments.

The various embodiments described above may be used in a variety of situations to enhance the operation of computer system 100. As one example, a virtualization provider may share a storage device 106 among multiple users with each user assigned to their own namespace. The provider may supply a standard install for each user that includes, e.g., an operating system, common applications, and/or supported utilities. This install may be used as a reference namespace and each user may be provided with a distinct snapshot namespace that is based on the reference namespace. The memory 116 of the storage device 106 that is not used by the reference namespace may be made available to the snapshot namespaces. The initialization of a user's namespace via a create snapshot namespace operation would occur very quickly and the snapshot namespace would not use additional physical storage until the user committed writes of new data.

As another example, a snapshot namespace may be used as a typical storage snapshot. A user with data in a namespace could create a snapshot namespace that used the data as a reference namespace. This would allow the user to create an atomic backup of a live data set while avoiding the halting of user operations upon this data set.

As another example, a user might define a protected reference namespace that holds secure information such as an operating system. Day to day use of this protected information may be accomplished by using a snapshot namespace. Thus, any malicious agent attempting to alter or destroy the protected information would, at worst, only alter the data within the snapshot namespace. Data within the reference namespace would be safe from such attempts and recovery from such malicious actions would be fast and simple. Such a system could also be used to contain, diagnose, and determine preventative measures for such malicious agents.

In particular embodiments, a CPU 102 and a storage device 106 may implement functionality described herein by implementing vendor specific commands (alternatively the commands described herein may be standardized in a future version of the NVMe specification). In various embodiments, the implementation of namespaces defined in an NVMe specification (e.g., NVM Express Revision 1.2a) may be leveraged and extended. For example, the implementation of namespaces may be extended through vendor specific commands including a create snapshot namespace command, a merge snapshot namespace command, and a delete snapshot namespace command.

The vendor specific create snapshot namespace command may result in the creation of a snapshot namespace on the storage device 106 (as described above). The metadata associated with a snapshot namespace created through the vendor specific create snapshot namespace command includes the namespace ID (NSID) of the reference namespace upon which the snapshot namespace is based (as well as an NSID of the snapshot namespace). Commands (e.g., write and read commands) directed towards the namespace from the CPU 102 may include the NSID of the snapshot namespace.

The vendor specific merge snapshot namespace command may result in the merging of two namespaces in a manner similar to that described above. The vendor specific delete snapshot namespace command may result in the deletion of a snapshot namespace (which may involve unmapping logical blocks of the snapshot namespace to the reference namespace and the deletion or deallocation of physical blocks used to store updated data of the snapshot namespace).

In various embodiments, an indicator may be added to entries of an L2P indirection table that specifies, for a particular logical block of the snapshot namespace, whether data should be accessed from the reference namespace or a physical block allocated for the snapshot namespace (where the physical block may include a modified copy of the data from the reference namespace). In particular embodiments, firmware of the storage device 106 may handle changes to the reference namespace atomically with any snapshot namespaces that reference the reference namespace and implement the copy on write functionality described herein (i.e., when a snapshot namespace writes to a logical block, the data from the reference namespace may be copied to a new physical block for the snapshot namespace by the firmware prior to performance of the write).

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software based hardware models, and HDL and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of system on chip (SoC) and other hardware device. In some instances, the HDL object can be used as the basis for developing models and design files that can be used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Logic may be used to implement any of the functionality of the various components such as CPU 102, external I/O controller 104, processor 108, core 114, I/O controller 110, CPU memory controller 112, storage device 106, memory 116, storage device controller 118, address translation engine 120, L2P indirection tables 124, encryption engine 128, or other entity or component described herein. “Logic” may refer to hardware, firmware, software and/or combinations of each to perform one or more functions. In various embodiments, logic may include a microprocessor or other processing element operable to execute software instructions, discrete logic such as an application specific integrated circuit (ASIC), a programmed logic device such as a field programmable gate array (FPGA), a storage device containing instructions, combinations of logic devices (e.g., as would be found on a printed circuit board), or other suitable hardware and/or software. Logic may include one or more gates or other circuit components. In some embodiments, logic may also be fully embodied as software. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in storage devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash storage devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

In at least one embodiment, an apparatus comprises a storage device to store a reference namespace comprising a plurality of logical blocks that correspond to physical blocks of a memory; receive a request to create a first snapshot namespace based on the reference namespace; and initialize a plurality of logical blocks of the first snapshot namespace to map to corresponding logical blocks of the reference namespace.

In an embodiment, the storage device is further to receive a request to create a second snapshot namespace based on thed reference namespace; and initialize a plurality of logical blocks of the second snapshot namespace to map to corresponding logical blocks of the reference namespace. In an embodiment, the corresponding logical blocks of the reference namespace map to an operating system stored by the storage device, the first snapshot namespace is assigned to a first user of the apparatus, and the second snapshot namespace is assigned to a second user of the apparatus. In an embodiment, the storage device is further to receive a request to create a second snapshot namespace based on the first snapshot namespace; and initialize a plurality of logical blocks of the second snapshot namespace to map to corresponding logical blocks of the first snapshot namespace. In an embodiment, the storage device is further to in response to receiving a command to write data to a logical block of the first snapshot namespace: determine that the logical block of the first snapshot namespace maps to a logical block of the reference namespace; map a first physical block in the memory to the logical block of the first snapshot namespace; copy data from a second physical block to the first physical block, the second physical block mapped to by the logical block of the reference namespace; and write the data of the command to the first physical block. In an embodiment, the storage device is further to in response to receiving a command to write data to a logical block of the first snapshot namespace: determine that the logical block of the first snapshot namespace is empty; map a physical block in the memory to the logical block of the first snapshot namespace; and write the data of the command to the allocated physical block. In an embodiment, the storage device is further to: in response to a request to merge the reference namespace and the first snapshot namespace, cause a logical block of the reference namespace to map to a physical block of the memory, the physical block storing data written to the first snapshot namespace. In an embodiment, the storage device is further to: in response to the request to merge the reference namespace and the first snapshot namespace, cause a logical block of the first snapshot namespace that maps to the physical block of the memory to map to the logical block of the reference namespace. In an embodiment, the storage device is further to in response to a request to roll back the first snapshot namespace: deallocate a physical block storing data of the first snapshot namespace, the physical block mapped to by a logical block of the first snapshot namespace; and cause the logical block of the first snapshot namespace to map to a logical block of the reference namespace. In an embodiment, initializing a plurality of logical blocks of the first snapshot namespace to map to corresponding logical blocks of the reference namespace comprises initializing a plurality of entries of a logical to physical indirection (L2P) table of the first snapshot namespace to map to corresponding entries of an L2P table of the reference namespace.

In at least one embodiment, a method comprises storing a reference namespace comprising a plurality of logical blocks that correspond to physical blocks of a memory; receiving a request to create a first snapshot namespace based on the reference namespace; and initializing a plurality of logical blocks of the first snapshot namespace to map to corresponding logical blocks of the reference namespace.

In an embodiment, the method further comprises receiving a request to create a second snapshot namespace based on the reference namespace; and initializing a plurality of logical blocks of the second snapshot namespace to map to corresponding logical blocks of the reference namespace. In an embodiment, the corresponding logical blocks of the reference namespace map to an operating system stored by the storage device, the first snapshot namespace is assigned to a first user of the apparatus, and the second snapshot namespace is assigned to a second user of the apparatus. In an embodiment, the method further comprises receiving a request to create a second snapshot namespace based on the first snapshot namespace; and initializing a plurality of logical blocks of the second snapshot namespace to map to corresponding logical blocks of the first snapshot namespace. In an embodiment, the method further comprises in response to receiving a command to write data to a logical block of the first snapshot namespace: determining that the logical block of the first snapshot namespace maps to a logical block of the reference namespace; mapping a first physical block of the memory to the logical block of the first snapshot namespace; copying data from a second physical block to the first physical block, the second physical block mapped to by the logical block of the reference namespace; and writing the data of the command to the first physical block. In an embodiment, the method further comprises in response to receiving a command to write data to a logical block of the first snapshot namespace: determining that the logical block of the first snapshot namespace is empty; mapping a physical block in the memory to the logical block of the first snapshot namespace; and writing the data of the command to the allocated physical block. In an embodiment, the method further comprises in response to a request to merge the reference namespace and the first snapshot namespace, causing a logical block of the reference namespace to map to a physical block of the memory, the physical block storing data written to the first snapshot namespace. In an embodiment, the method further comprises in response to the request to merge the reference namespace and the first snapshot namespace, causing a logical block of the first snapshot namespace that maps to the physical block of the memory to map to the logical block of the reference namespace. In an embodiment, the method further comprises in response to a request to roll back the first snapshot namespace: deallocating a physical block storing data of the first snapshot namespace, the physical block mapped to by a logical block of the first snapshot namespace; and causing the logical block of the first snapshot namespace to map to a logical block of the reference namespace. In an embodiment, initializing a plurality of logical blocks of the first snapshot namespace to map to corresponding logical blocks of the reference namespace comprises initializing a plurality of entries of a logical to physical indirection (L2P) table of the first snapshot namespace to map to corresponding entries of an L2P table of the reference namespace. In an embodiment, the method further comprises receiving a read request identifying a logical block of the first snapshot namespace; determining that the logical block of the first snapshot namespace maps to a logical block of the reference namespace; and reading from a physical block of the memory based on a physical address mapped to the logical block of the reference namespace. In an embodiment, the method further comprises receiving a request to delete a logical block of the first snapshot namespace; and causing the logical block to no longer map to a logical block of the reference namespace in response to the request.

In at least one embodiment, a system comprises a processor to issue a request to create a snapshot namespace; and a storage device comprising a memory to store a plurality of physical blocks that correspond to a plurality of logical blocks of a reference namespace; and a storage device controller to receive a request to create a first snapshot namespace based on the reference namespace; and initialize a plurality of logical blocks of the first snapshot namespace to map to corresponding logical blocks of the reference namespace.

In an embodiment, the system further comprises one or more of: a battery communicatively coupled to the processor, a display communicatively coupled to the processor, or a network interface communicatively coupled to the processor.

In at least one embodiment an apparatus comprises means for storing a reference namespace comprising a plurality of logical blocks that correspond to physical blocks of a memory; means for receiving a request to create a first snapshot namespace based on the reference namespace; and means for creating the first snapshot namespace and initialize a plurality of logical blocks of the first snapshot namespace to map to corresponding logical blocks of the reference namespace.

In an embodiment, the apparatus further comprises means for receiving a request to create a second snapshot namespace based on the reference namespace; and means for creating the second snapshot namespace and initializing a plurality of logical blocks of the second snapshot namespace to map to corresponding logical blocks of the reference namespace. In an embodiment, the apparatus further comprises means for receiving a request to create a second snapshot namespace based on the first snapshot namespace; and means for creating the second snapshot namespace and initializing a plurality of logical blocks of the second snapshot namespace to map to corresponding logical blocks of the first snapshot namespace. In an embodiment, the apparatus further comprise means for in response to receiving a command to write data to a logical block of the first snapshot namespace: determining that the logical block of the first snapshot namespace maps to a logical block of the reference namespace; mapping a first physical block of the memory to the logical block of the first snapshot namespace; copying data from a second physical block to the first physical block, the second physical block mapped to by the logical block of the reference namespace; and writing the data of the command to the first physical block. In an embodiment, the apparatus further comprises means for: in response to receiving a command to write data to a logical block of the first snapshot namespace: determining that the logical block of the first snapshot namespace is empty; mapping a physical block in the memory to the logical block of the first snapshot namespace; and writing the data of the command to the allocated physical block.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An apparatus comprising:
a storage device to:
store a reference namespace comprising a plurality of logical blocks that correspond to physical blocks of a memory;
receive a request to create a first snapshot namespace based on the reference namespace; and
initialize a plurality of logical blocks of the first snapshot namespace to map to corresponding logical blocks of the reference namespace.

2. The apparatus of claim 1, the storage device further to:
receive a request to create a second snapshot namespace based on the reference namespace; and
initialize a plurality of logical blocks of the second snapshot namespace to map to corresponding logical blocks of the reference namespace.

3. The apparatus of claim 2, wherein the corresponding logical blocks of the reference namespace map to an operating system stored by the storage device, the first snapshot namespace is assigned to a first user of the apparatus, and the second snapshot namespace is assigned to a second user of the apparatus.

4. The apparatus of claim 1, the storage device further to:
receive a request to create a second snapshot namespace based on the first snapshot namespace; and
initialize a plurality of logical blocks of the second snapshot namespace to map to corresponding logical blocks of the first snapshot namespace.

5. The apparatus of claim 1, the storage device further to:
in response to receiving a command to write data to a logical block of the first snapshot namespace:
determine that the logical block of the first snapshot namespace maps to a logical block of the reference namespace;
map a first physical block in the memory to the logical block of the first snapshot namespace;
copy data from a second physical block to the first physical block, the second physical block pointed to by the logical block of the reference namespace; and
write the data of the command to the first physical block.

6. The apparatus of claim 1, the storage device further to:
in response to receiving a command to write data to a logical block of the first snapshot namespace:
determine that the logical block of the first snapshot namespace is empty;
map a physical block in the memory to the logical block of the first snapshot namespace; and
write the data of the command to the allocated physical block.

7. The apparatus of claim 1, the storage device further to:
in response to a request to merge the reference namespace and the first snapshot namespace, cause a logical block of the reference namespace to map to a physical block of the memory, the physical block storing data written to the first snapshot namespace.

8. The apparatus of claim 7, the storage device further to:
in response to the request to merge the reference namespace and the first snapshot namespace, cause a logical block of the first snapshot namespace that maps to the physical block of the memory to map to the logical block of the reference namespace.

9. The apparatus of claim 1, the storage device further to:
in response to a request to roll back the first snapshot namespace:
deallocate a physical block storing data of the first snapshot namespace, the physical block pointed to by a logical block of the first snapshot namespace; and
cause the logical block of the first snapshot namespace to map to a logical block of the reference namespace.

10. The apparatus of claim 1, wherein initializing a plurality of logical blocks of the first snapshot namespace to map to corresponding logical blocks of the reference namespace comprises initializing a plurality of entries of a logical to physical indirection (L2P) table of the first snapshot namespace to map to corresponding entries of an L2P table of the reference namespace.

11. A method comprising:
storing a reference namespace comprising a plurality of logical blocks that correspond to physical blocks of a memory;
receiving a request to create a first snapshot namespace based on the reference namespace; and
initializing a plurality of logical blocks of the first snapshot namespace to map to corresponding logical blocks of the reference namespace.

12. The method of claim 11, further comprising:
receiving a request to create a second snapshot namespace based on the reference namespace; and
initializing a plurality of logical blocks of the second snapshot namespace to map to corresponding logical blocks of the reference namespace.

13. The method of claim 11, further comprising:
receiving a request to create a second snapshot namespace based on the first snapshot namespace; and
initializing a plurality of logical blocks of the second snapshot namespace to map to corresponding logical blocks of the first snapshot namespace.

14. The method of claim 11, further comprising:
in response to receiving a command to write data to a logical block of the first snapshot namespace:
determining that the logical block of the first snapshot namespace maps to a logical block of the reference namespace;
mapping a first physical block of the memory to the logical block of the first snapshot namespace;
copying data from a second physical block to the first physical block, the second physical block pointed to by the logical block of the reference namespace; and
writing the data of the command to the first physical block.

15. The method of claim 11, further comprising:
in response to receiving a command to write data to a logical block of the first snapshot namespace:
determining that the logical block of the first snapshot namespace is empty;
mapping a physical block in the memory to the logical block of the first snapshot namespace; and
writing the data of the command to the allocated physical block.

16. The method of claim 11, further comprising:
in response to a request to merge the reference namespace and the first snapshot namespace, causing a logical block of the reference namespace to map to a physical block of the memory, the physical block storing data written to the first snapshot namespace.

17. The method of claim 16, further comprising:
in response to the request to merge the reference namespace and the first snapshot namespace, causing a logical block of the first snapshot namespace that maps to the physical block of the memory to map to the logical block of the reference namespace.

18. The method of claim 11, further comprising:
in response to a request to roll back the first snapshot namespace:
deallocating a physical block storing data of the first snapshot namespace, the physical block pointed to by a logical block of the first snapshot namespace; and
causing the logical block of the first snapshot namespace to map to a logical block of the reference namespace.

19. A system to comprise:
a processor to issue a request to create a snapshot namespace; and
a storage device comprising:
a memory to store a plurality of physical blocks that correspond to a plurality of logical blocks of a reference namespace; and
a storage device controller to:
receive a request to create a first snapshot namespace based on the reference namespace; and
initialize a plurality of logical blocks of the first snapshot namespace to map to corresponding logical blocks of the reference namespace.

20. The system of claim 19, further comprising one or more of: a battery communicatively coupled to the processor, a display communicatively coupled to the processor, or a network interface communicatively coupled to the processor.
